(19) United States
(12) Patent Application Publication
(10) Pub. No.: US 2025/0292180 A1
(43) Pub. Date: Sep. 18, 2025

(54) AN ADVANCED DATA AND ANALYTICS MANAGEMENT PLATFORM

(71) Applicant: MTN GROUP MANAGEMENT SERVICES (PROPRIETARY) LIMITED, Gauteng (ZA)

(72) Inventors: Rizwan Haroon BHAWRA, Sandton (ZA); Chika EKEJI, Johannesburg (ZA); Michael Geoffrey BELL, Hartbeespoort Northwest (ZA); Masindi Abraham MABOGO, Roodepoort (ZA); Nikolaos ANGELOPOULOS, Johannesburg (ZA)

(21) Appl. No.: 18/861,473

(22) PCT Filed: May 1, 2023
(86) PCT No.: PCT/IB2023/054520

§ 371 Date: Oct. 29, 2024

(30) Foreign Application Priority Data
Apr. 29, 2022 (ZA) 2022/04760

(51) Int. Cl. G06Q 10/0639; G06Q 30/0601

(52) U.S. Cl. CPC G06Q 10/0639; G06Q 30/0631

(57) ABSTRACT

A advanced data management platform, method, and system allowing for several users to remotely access a centralized database and use analytical tools, models, and algorithms to analyse and extract predictive information, trends and the like from data sets. Moreover, the data management platform, method, and system includes the option of allowing for data analysis and model training with anonymized data. This then further allows for the trained model to be applied on data sets located outside of the data platform and/or system to derive predictive information about that data set.

### FIELD OF THE INVENTION

The invention relates to an advanced data and analytics management platform. The invention also relates to systems and methods for implementing an advanced data and analytics management platform.

### BACKGROUND TO THE INVENTION

In many traditional organisations, the standard practice is to purge data after a certain period of time, or, at best, retain data in conventional data warehouses for purposes of long-term storage and basic reporting.

In recent years, organisations have started dealing with data in more sophisticated and advanced ways, at least in part influenced by the latest buzzwords, success stories and trends in publications and seminars. As part of this process, there has been greater investment, albeit in many cases arbitrarily, in different and disparate, “analytical” solutions or tools.

In this transitional phase both from an organisational and a technology perspective, different teams and departments within an organisation or group may be joining the above “movement”—some in a more modest way, and others rather enthusiastically, with many teams or departments investing in data and analytics tools through their vendors (both traditional and new).

As a result, there is a risk of creating scattered data and analytical resources, rather than a uniform, holistic, enterprise-wide, end-to-end solution (particularly in large organisations). Some of the drawbacks of such a scattered system include siloed data stores, suboptimal elementary analytical resources, uncoordinated incompatible actions, leading to subdued results, waste or duplication of organisational budgets, resources, and lost opportunities. Furthermore, these arbitrary, unconcerted, disparate approaches and the myriads of assets amassed create new and/or reinforce existing organisational silos. There is no single “source-of-truth” and single “point-of-data”—and this applies for analytical repositories and references. For example, a single key performance indicator (KPI), process or use case may be defined and implemented differently within the same organisation by different teams. This may in turn result, for instance, in the same KPI being reported differently, with different values (figures) communicated across the organisation and externally, for example, to the investors and regulators. This can have a detrimental effect on an organisation's performance, image, governance and/or benchmarks.

These distributed, uncorrelated and uncoordinated approaches towards analytics, unaware of “each other”, work unharmoniously, instead of in tandem, towards common effects and goals within an organisation. The practical result is suboptimal and often adverse due to mutual cannibalisation, push-pull effect, etc.

Another critical problem in this regard is the non-availability of suitable variety and amount of data for data science activities. Analytics is often at its most effective when there is a marriage of different types of large amounts of data and the use of sophisticated analytical means. In a large organisation, each department or function may depend on another to fulfil the overall organisation's offerings to its customers. Similarly, for data and analytics, the fusion of different data and external data points can help to achieve the organisation's true analytical potential.

In the absence of the above, the siloed approach with no centralised, dedicated data and analytical platform may result in analytical assets (such as machine learning (ML) models) having suboptimal efficacy and prediction power. This leads to predictions and decisions that are not highly accurate and impactful. Since there is no single point of development with the correct and complete data, and the associated ecosystem and single point of production, many of these analytical assets may remain in an individual's machine (e.g. locally on a laptop) without being productionalized (implemented on business or IT systems) to benefit the organisation. Naturally this results in considerable duplication and waste, together with the other issues already mentioned above.

It has been found that a common failure in leveraging an organisation's big data assets to drive commercial value is typically not the creation of good and actionable insights through ML models, but rather the application thereof. Building these models into productionalized business systems is generally where data science teams fail (as opposed to failing in the development of the models themselves), and the majority of the resource effort may be focused.

In light of the above, a need was identified for a holistic, end-to-end solution capable of addressing at least some of these issues. The Inventor attempted to find a solution in the public domain based on his multi-domain, cross-industry experience, but he found that a single “ready-made” tool or solution was not available. This was not surprising, due to the variety of requirements, components, processes, and services required to create such an end-to-end solution.

While research has been done in this field and some entities have developed products/services that address aspects of the problem, e.g. Google's “Colossus” and “Bigtable” products, existing functionality is limited and they do not provide the comprehensive solution required. In particular, the Applicant was unable to find an end-to-end, holistic analytic cycle solution allowing for myriads of components, services, processes, and capabilities to interact harmoniously, while being vendor agnostic. In order to address this need, the Inventor thus developed the present invention.

### SUMMARY OF THE INVENTION

In accordance with the invention, broadly, there is provided an advanced data and analytics management platform. Aspects of the invention may include methods of operating the platform and systems forming part of or coupled to the platform, as described below and/or depicted in the drawings.

The advanced data and analytics management platform is, for ease of reference, referred to using the acronym “ADAM” below and in some of the drawings.

The ADAM platform is configured to provide a central and single source of development, management, production, repository, and monitoring for all analytical assets (particularly the advanced analytical tools) across an organisation, e.g. an organisation including a group of companies or multiple groups of companies. In examples below and in the drawings, the organisation is MTN including its operating companies (OpCos). The OpCos may be spread across multiple countries and in some countries there may be one OpCo per country in which the business operates. It will be appreciated that references to MTN are merely examples and the ADAM platform may be applied across different industries and organisations. In the case of MTN, local/on-premise data systems may be referred to as “EVA” systems and reference is thus made to integration of EVA systems with the ADAM platform.

The ADAM platform may provide a data science workbench and asset management platform to mature the capability to exploit data in an organisation. The ADAM platform may assist in proliferating data science in an organisation, promoting native talent and empowering business streams.

Preferably, the platform should be centrally located, easily and securely accessible from anywhere, having a suitable variety and amount of data (which may be legally vetted), with a full analytical resource ecosystem, connected to each operating company within a group, and the means to create, reuse and industrialise (automate) data or analytical resources across the group's footprint, on-premises in the OpCo, in the cloud or at the edge (e.g. a mall or airport, etc.), or at a business-to-business client.

Essentially, the ADAM platform may be configured to function as an analytic factory and/or as an analytics-as-a-service platform, e.g. a one-stop-shop for collaboration, analytical code repository, model catalogue, CICD (continuous integration, continuous development) pipeline, for vital organisational data sources (points), analytical assets, with supporting analytical algorithms, languages, and the like.

The ADAM platform may include one or more of the following components/features:
the ready availability of a high-volume wide variety of curated organisational data and external data in a single logical location;
support for various analytics tools and languages;
access to modelling algorithm libraries, vetted and downloaded in a secure organisational internal environment;
the ability to support various kinds of analytics (for example, AI/ML/DL/Heuristics/Simulations, etc.);
connection to different organisational entities, e.g. group and OpCo data source systems;
ability to upload data, download model code and again upload model performance for monitoring, e.g. via CICD pipeline(s); and/or
productionalized (industrialised) easily for automated and regular generation of actionable insights, insights based actions, and/or predictions.

The platform may empower users from data scientists through to basic analysts to use their preferred technologies, programming languages, and analytical algorithm libraries in an environment that is part of the broader enterprise-wide infrastructure, connected and accessible from anywhere. In use, users such as data scientists may connect directly to the data sources in the central data lake(s) with minimal setup and increase business productivity.

Using ML/AI models as an example, the platform thus provides a technical solution which may facilitate “unleashing” the value of ML/AI across a large organisation.

Embodiments of the invention may extend to one or more computer program product for implementing the ADAM platform, the computer program product comprising at least one computer-readable storage medium having program instructions embodied therewith, the program instructions being executable by at least one computer to cause the at least one computer to carry out techniques and implement features substantially as described above.

The computer-readable storage medium may be a non-transitory storage medium. The computer program product may be implemented across multiple devices and locations, etc.

The ADAM platform may be or include any suitable computer or server. The computer ADAM platform may be implemented in distributed cloud computing environments where tasks are performed by remote processing devices that are linked through a communications network. In a distributed cloud computing environment, program modules executed by the ADAM platform may be located both locally and remotely.

According to a first aspect of the invention, there is provided a data management platform comprising:
a centralized database having benchmark data stored thereon, the centralized database configured to receive one or more data sets from one or more data sources, and wherein the centralized database allows for one or more users to remotely access the centralized database;
an analytics module communicatively coupled to the centralized database, the analytics module comprising one or more analytics tools which allows for data analysis of the one or more data sets; and
a model module communicatively coupled to the centralized database, the model module comprising one or more algorithms for performing a set of instructions on the one or more data sets, wherein the model module is capable of being trained by the one or more algorithms by comparing the one or more data sets to the benchmark data to derive one or more output data sets having predictive information about the one or more data sets.

The one or more data sources may be one or more data warehouses locatable in one or more countries. The one or more data sets may comprise customer data.

The data management platform may be configured to allow for the one or more users to remotely access the centralized database through a network connection to transfer one or more data sets from one or more data sources to the centralized database, wherein the network connection allows for the one or more users to use the analytics module comprising analytics tools to analyse the one or more data sets, and wherein the network connection allows for the one or more users to train the model module comprising one or more algorithms by comparing the one or more data sets to the benchmark data to derive an output dataset having predictive information about the one or more data sets.

The analytics module comprising one or more analytics tools and the model module comprising one or more algorithms may be dynamically updated and evolve with each instance of the one or more analytics tools analysing the one or more data sets and the model module being trained by the one or more algorithms by comparing the one or more data sets to the benchmark data to derive one or more output data sets having predictive information about the one or more data sets.

Dynamically updating may refer to the uploading of data in real time.

Evolving may be the improvement in operations of the analytics module and the model module, where the analytics module will provide improve data analysis and the model module will be capable of providing faster and stronger predictive information when applied on one or more data sets.

The benchmark data may be dynamically updated with each instance of the one or more data sets being compared to the benchmark data.

The training of the model module comprising one or more algorithms may allow for each subsequent output dataset having predictive information derived to be faster and include additional predictive insights related to the one or more data sets.

The data management platform may further comprise a processing module for processing data into one or more vectors.

The one or more vectors may be segmented into one or more use case.

Each use case may configured to be employed for a particular purpose.

Each purpose may be the employment of the vectors for a particular type of data.

The one or more vectors are stored as a repository on the data management platform, wherein one or more users may remotely access the repository to facilitate the application of the model module comprising one or more algorithms on one or more data sets.

The availability of the one or more vectors stored as a repository on the data management platform may allow for the model module comprising one or more algorithms to be applied on one or more data sets locatable in one or more countries.

The availability of the one or more vectors stored as a repository on the data management platform may allow for the model module comprising one or more algorithms to be applied on one or more data sets with lower latency than transmitting one or more data sets to the data management platform.

The network connection may be either secure, private, or a combination thereof.

The one or more data sources may be one or more data warehouses locatable in one or more countries.

The centralized database may be configured to only receive one or more data sets that have been anonymized to derive anonymized data.

The one or more analytics tools may be selected from the group consisting of Tableau, Oracle Business Intelligence, IBM Cognos Analytics, SAS, Microsoft Power BI, Amazon Redshift, Google BigQuery, Snowflake, Alteryx, Cloudera, Apache Hadoop, Google Vertex AI, Microsoft Azure Synapse, Microsoft Data Explorer, CosmosDB, Redis, Azure Cognitive Services, Azure Machine Learning, Spark, Databricks, Sqream, Confluent Kafka, Presto, Trino, Flare, HIDS, and combinations thereof.

The one or more algorithms may be selected from the group consisting of a machine learning algorithm, an artificial intelligence algorithm, a deep learning algorithm, a heuristic algorithm, and combinations thereof.

The one or more data sets may comprise customer usage information selected from the group consisting of customer voicecall usage, customer screentime usage, customer data usage, customer messaging usage, customer device hardware specifications, customer transactions, customer interactions, customer behaviour, customer revenue, network operations, network usage, network investment, internal operations, sale information, distribution information, agent operations, merchant operation, agent services, merchant operation, business to business products, business to business products services, digital products, over-the-top applications, customer value management, pricing, operations management, portfolio management, customer location, network location, network transport, network configuration, cybersecurity, and combinations thereof.

The one or more data sets may comprise information may be selected from customer information related to the customer's usage consisting of voice, internet, data, payments, digital services, enterprise services, network solutions, and combinations thereof.

The predictive information may comprise information about the customer's behaviour to derive a user-specific product offering.

An example of the user-specific product offering may be offer the customer one or more products that are correlated with the predictive information derived for the customer by the model module and the one or more algorithms.

A more specific example of the user-specific product offering may to recommend one or more products comprising voice minutes, data, or a combination thereof to the customer.

The predictive information may include information to indicate what would be the preferred format of communication to increase the likelihood that the client will purchase the product offering.

The data management platform may comprise a data transmission module for transmission of the model module to a database that is locatable outside of the centralized database, wherein the model module comprising one or more algorithms is capable of being applied on one or more data sets available on the database to derive an output dataset having predictive information about the one or more data sets.

The data transmission module may allow for the trained model module and the one or more algorithms to be stored on a computer-readable storage medium.

The computer-readable storage medium may be a non-transitory storage medium.

The computer-readable storage medium may also be remote storage which may comprise one or more instances or units of cloud storage, remote server, a plurality of processors communicative coupled to one another, computers, and combinations thereof.

The model module may be uploaded to any device or medium comprising one or more data sets, wherein the model module is then applied on the one or more data sets.

Uploading of the model module to a location locatable outside of the data management platform may allow for decreased latency.

Uploading of the model module to a location locatable outside of the data management platform may allow for the model module to be applied on one or more data sets at a location where allowing for the one or more data sets to be removed from the location would breach one or more data regulations.

Uploading of the model module to a location locatable outside of the data management platform may allow for a model module that has been trained by anonymized data on the data management platform to derive predictive information about one or more data sets at that location, wherein the predictive information may be used to derive a user-specific product offering for one or more customers included in the one or more data sets at that location.

The data management platform may further comprise an anonymizing module locatable outside of the centralized database, the anonymizing module comprising:
a data module for receiving the one or more data sets from one or more data sources;
an anonymizing algorithm for anonymizing the one or more data sets to derive anonymized data; and
a transmission module for transmission of the anonymized data to the centralized database.

The anonymized data may be used to train the model module comprising one or more algorithms by comparing the anonymized data to benchmark data stored on the centralized database to derive an output dataset having predictive information about the anonymized data.

The model module comprising one or more algorithms may configured to be trained by anonymized data, and wherein the model module is applied on one or more data sets locatable at a selected location to comply with country-specific data protection and privacy regulation regulations.

The data management platform may be communicatively coupled to external datasource having one or more data sets stored thereon, wherein the external datasource is locatable outside of the platform.

The one or more data sets stored on the datasource may be anonymized by an anonymizing module to derive anonymized data. The model module comprising one or more algorithms may be trained by anonymized data receivable by the centralized database, wherein the trained model module comprising one or more algorithms may be applied on one or more data sets locatable on a datasource locatable at a location outside of the centralized database.

The data management platform may further comprise an interface module which is communicatively coupled to the model module to receive the predictive information about the one or more data sets, and which is communicatively coupled to one or more user devices, thereby allowing the user devices to access the predictive information about the one or more data sets.

According to a second aspect of the invention, there is provided a method for training a model with anonymized data and applying the model on one or more data sets located at a selected location, the method comprising the steps of:
providing a database having benchmark data stored thereon, wherein the database is capable of receiving data from one or more data sources;
providing an external data source that is communicatively coupled to the database, wherein one or more data sets stored on the external data source is anonymized by performing a set of instructions thereon to derive anonymized data;
using one or more analytics tools to allow for data analysis of data stored on the database;
training a model comprising one or more algorithms by comparing the anonymized data to the benchmark data;
applying the trained model on one or more data sets that are locatable outside of the database to derive predictive information about the one or more data sets.

The method may comprise the step of storing the model on a storage medium, which allows for the model to be applied on one or more data sets that are located any source that is communicatively coupled to the storage medium.

The method may comprise the step of using the predictive information to derive a user-specific product offering.

According to a third aspect of the invention, there is provided a digital management system comprising:
a computing device comprising a processor communicatively coupled to a memory which is capable of storing one or more data sets obtainable from one or more data sources thereon, the memory having benchmark data stored thereon;
an analytics module comprising analytical tools, the analytics module communicatively coupled to the memory, wherein the processor is capable of carrying out a set of instructions for the analytical tools to perform analytical operations on the one or more data sets; and
a model module comprising one or more algorithms, the model module communicatively coupled to the memory, wherein the model module is capable of being trained by the processor applying the one or more algorithms by comparing the one or more data sets to benchmark data to derive an output dataset having predictive information about the one or more data sets.

The memory may be selected from the group consisting of non-transitory storage medium, transitory storage medium, and combinations thereof.

According to a fourth aspect of the invention, there is provided a computer-readable storage medium storing instructions that when executed by a computer cause the computer to perform a method for using a computer system to train a model with anonymized data and applying the model on data located at a selected location, the method comprising the steps of:
providing a database having benchmark data stored thereon, wherein the database is capable of receiving data from one or more data sources;
providing an external data source that is communicatively coupled to the database, wherein one or more data sets stored on the external data source is anonymized by performing a set of instructions thereon to derive anonymized data;
using one or more analytics tools to analyze data stored on the database;
training a model comprising one or more algorithms by comparing the anonymized data to the benchmark data;
applying the trained model on an external data set that are locatable outside of the database to derive predictive information about the external data set.

### BRIEF DESCRIPTION OF THE DRAWINGS

The invention will now be further described, by way of example, with reference to the accompanying drawings. In the drawings:

FIG. 1 is a schematic diagram illustrating an example of the manner in which the ADAM platform may be integrated into an organisation's enterprise data system.

FIG. 2 is a schematic diagram illustrating how the ADAM platform is capable of interacting with anonymized data (Personally Identifiable Information or “PH” data) available through the EVA system.

FIG. 3 is a schematic diagram illustrating how the ADAM platform may be deployed as a “group platform”.

FIG. 4 is an exemplary data system architecture including an example of the ADAM platform.

FIG. 5 provides an illustration of a data pipeline between the ADAM platform and an on-premises system.

FIG. 6 provides an overview of an exemplary ADAM platform in operation.

FIG. 7 is a table detailing an exemplary platform's compliance with a first set of architectural principles.

FIG. 8 is a table detailing an exemplary platform's compliance with a second set of architectural principles.

FIG. 9 is a table detailing an exemplary platform's compliance with a third set of architectural principles.

FIG. 10 is a schematic diagram of an exemplary logical architecture that may be employed in embodiments of the invention.

FIG. 11 is a schematic diagram illustrating a first option for integrating a group instance of ADAM with operating companies in an organisation.

FIG. 12 is a schematic diagram illustrating a second option for integrating a group instance of ADAM with operating companies in an organisation.

FIG. 13 is a block diagram of an exemplary computer system capable of executing a computer program product to provide functions and/or actions according to various aspects of the invention.

### DETAILED DESCRIPTION OF EMBODIMENTS OF THE INVENTION

The following description is provided as an enabling teaching of the invention, is illustrative of principles associated with the invention and is not intended to limit the scope of the invention. Changes may be made to the embodiments depicted and described, while still attaining results of the present invention and/or without departing from the scope of the invention. Furthermore, it will be understood that some results or advantages of the present invention may be attained by selecting some of the features of the present invention without utilising other features. Accordingly, those skilled in the art will recognise that modifications and adaptations to the present invention may be possible and may even be desirable in certain circumstances, and may form part of the present invention.

Embodiments of the invention provide a “one-stop-shop”: a centralised platform for end-to-end analytics asset life cycle management. An example of such an asset is a ML model.

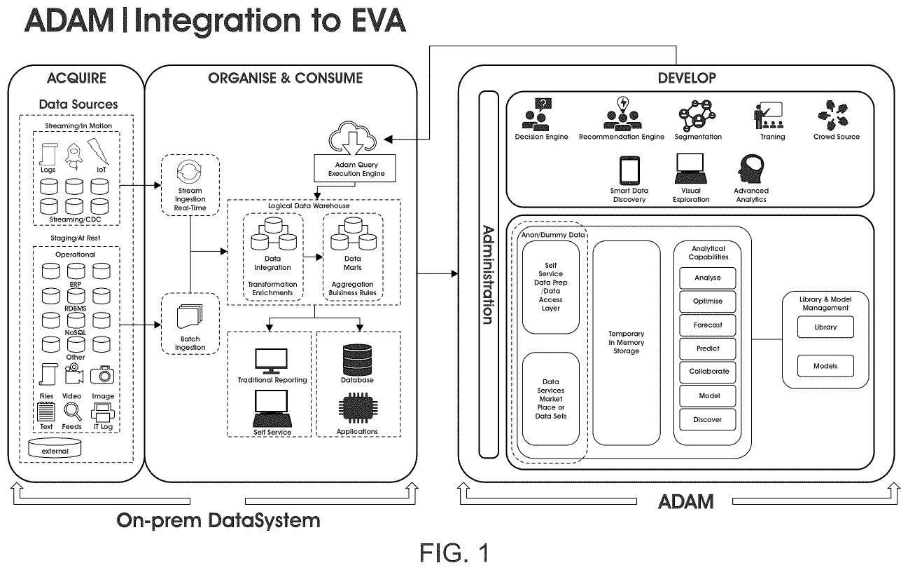

FIG. 1 is a schematic diagram illustrating an example of how the ADAM platform may be integrated into an organisation's enterprise data system. Data is received from various sources and stored in various formats, be it text, video, image and the like. Once stored, the data is then capable of being utilized through a series of operations as illustrated in the “Organise & Consume” zone. The operations then place the data in a suitable format whereby the ADAM platform is then capable of interacting with the data. This sequence of operations and transformation of the data is performed by each participant or contributor to the overall ADAM platform and is referred to as an EVA system as described above. Importantly, each location or country as whole will be one EVA system contributing one or more unique datasets.

Once the data has been suitable stored, the ADAM platform is capable of performing further operations thereon. Such operations will include, but is not limited to, analytics, visualization, modelling, training of the dataset through ML, DL, AI, heuristic and other algorithms, applications of ML, DL, AI, heuristic and other algorithms to analyze and make predictions related to the one or more data sets.

An important feature of the ADAM platform is its centralization, which allows for the platform to be exposed and trained by various datasets received from a variety of sources and sectors within one or more organizations. This allows for a marriage, integration, and/or “cross-pollination” of similar and unique datasets, which then further enables the ADAM platform to make unique predictions that would not be otherwise possible with a platform or model mostly trained by similar datasets.

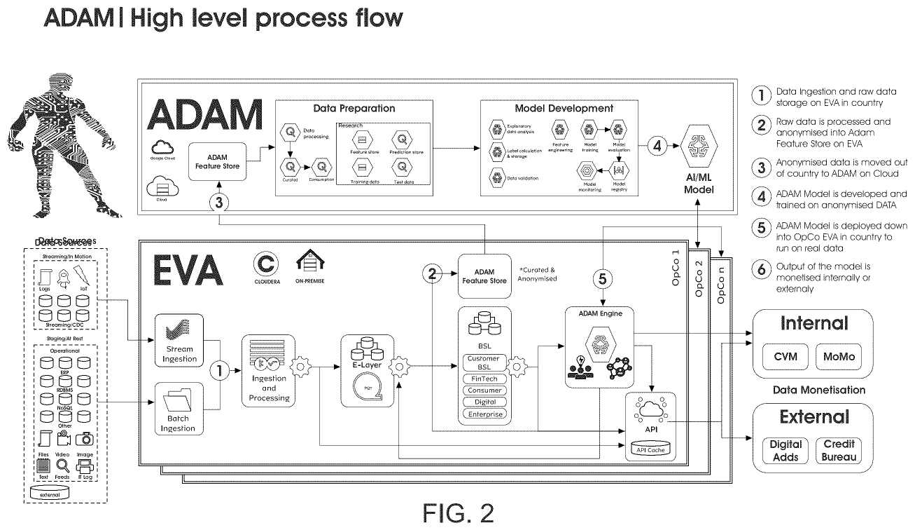

FIG. 2 is a schematic diagram illustrating how the ADAM platform is capable of interacting with anonymized data (Personally Identifiable Information or “PII” data) available through the EVA system. Firstly, raw data is obtained by the EVA system from each location or country. Secondly, the raw data is anonymized through a series of operations performed by the EVA system. Thirdly, the anonymized data is moved or transmitted from that location or country to the cloud-based server where the ADAM platform is centrally hosted. Fourthly, the format of the anonymized data still allows for the ADAM platform to query and train using the anonymized data. Fifthly, as opposed to the usual operation of sending or transmitting data to another medium capable of interacting therewith, the ADAM platform and its algorithms and/or models is deployed to each individual location or country to analyze and make predictions on real data. Sixthly, the resulting analysis and predictions are unique to each individual location or country as a result of the relevant data set available, which allows for the monetisation of these results at each EVA System (location or country).

This is an important feature of the invention as exporting the data out of each country will in all likelihood fall foul or breach data regulations such as GDRP or POPI. Therefore, using anonymized data to train the ADAM platform and associated models, and then employing the ADAM platform and associated models at each location on real data to obtain an analysis and make predictions allows for vast data lakes to be utilized without compromising user privacy.

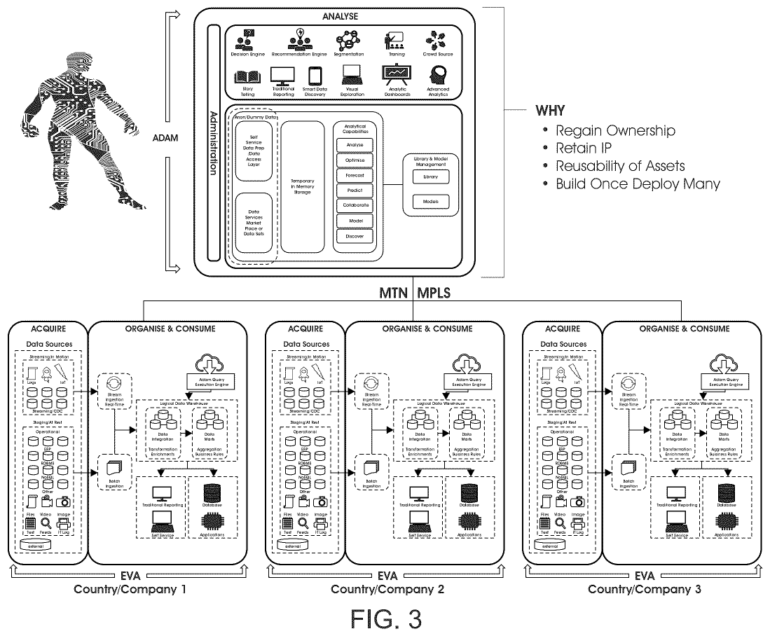

FIG. 3 is a schematic diagram illustrating how the ADAM platform can be deployed as a “group platform”. It may be connected via CICD to operating company data systems as described in FIG. 2 above. Advantages of this may include retaining IP and ownership, reusability of assets, and a “build once deploy many” approach.

In embodiments of the invention, the ADAM platform aims to prevent the issues and drawbacks mentioned above from happening by facilitating the process of model development through testing and into production. Without a solution like ADAM, the organisation's resources will have to build these systems, for instance, using open source (one man or team laptop-based) solutions, readily available but often with significant reliability and scalability challenges. The models will also require substantial effort to keep operationalised.

A typical estimation to productionalized an ML model (through such individual open-source technologies and approaches) can exceed 3 months; in embodiments of the ADAM platform, this can be reduced to for instance 2-3 weeks, with the same resource pool. This becomes critical when one considers the number of these models that businesses need today, to increase returns. The modelling teams in an organisation can thus use the platform as shown in the drawings to keep up with organisational demand.

Some key steps in the management and implementation of this platform may include:
Utilising a governance committee
Innovation hub, collaboration
Internal cloud source
Analytical asset (e.g. Model) end-to-end life cycle—DevOpS/MLOpS leading to AiOps Creation, Comparison, Agile delivery, Productionalization, Measurement, Retraining/Recreation, etc.

Some capabilities/modules of the platform may include:
Analytical asset catalogue
Analytical code repository
Self-healing models
Manage model
Central development & model management and collaboration environment
Decision science workbench—not necessarily only for ML, DL, but also simulation, forecasting, AI, etc.
Decentralization of development and deployment (make once, use many).
Compliant to organisation's data warehouse (e.g. MTN EVA/DaaS)
Batch or frequency model and streaming or real-time processing and modelling.
Access to model algorithms, packages and live libraries
Model interoperability
Execution
Decisions
Rules
Recommendations

Various users may interact with the ADAM platform in embodiments of the invention:
Data scientists
Coders—e.g. R, Python, SAS Miner, etc.
Model/release managers
Consumers—e.g. Insights, Excel jockeys, Business Analysts, Business and IT systems and processes, external B2B partners, etc.

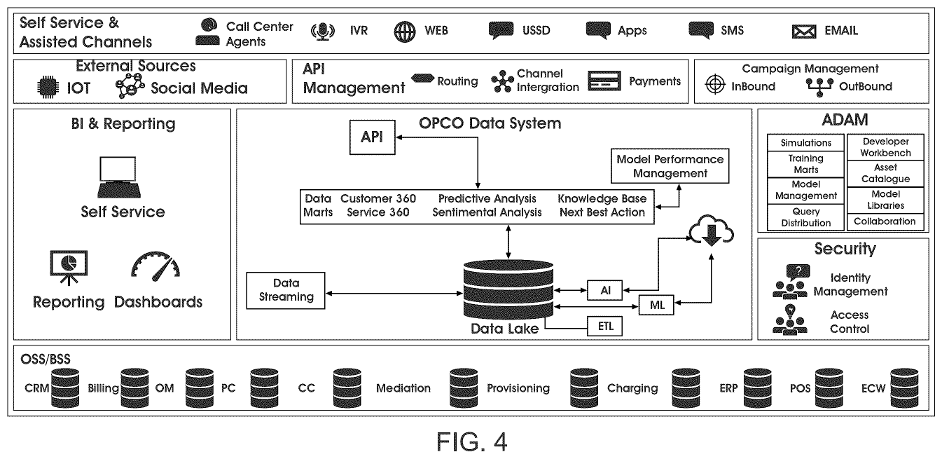

FIG. 4 is an exemplary data system architecture including an example of the ADAM platform. The exemplary ADAM platform includes access to data pertaining to OSS (Operations Support System) and BSS (Business Support System) software systems as typically used by telecommunications and other service providers to manage their operations and support their business functions. Furthermore, the ADAM platform allows for the visualization and importing of data from available and external data sources. Several API's are also integrated and immediately available. The ADAM model is then available to train and be deployed on the various data sets, including the large data lake that is constantly receiving additional data sets; thereby allowing for more efficient training of any subsequent data sets where the ADAM platform and model is deployed.

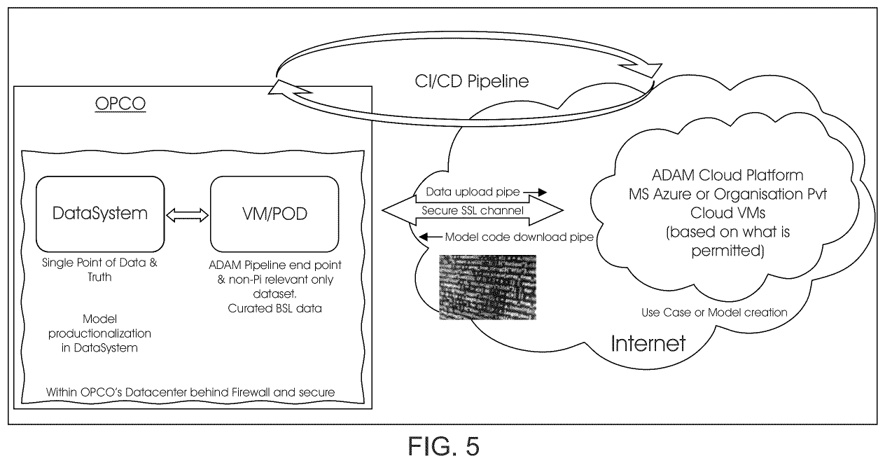

FIG. 5 provides an illustration of a data pipeline between the ADAM platform and an on-premises system. As discussed above, the on-premises data at each location or country is anonymized data before being transmitted or uploaded through a CI/CD (Continuous Integration/Continuous Delivery) to the ADAM platform. Once trained, the ADAM platform can be deployed at any premises by downloaded the model code for us on the real data.

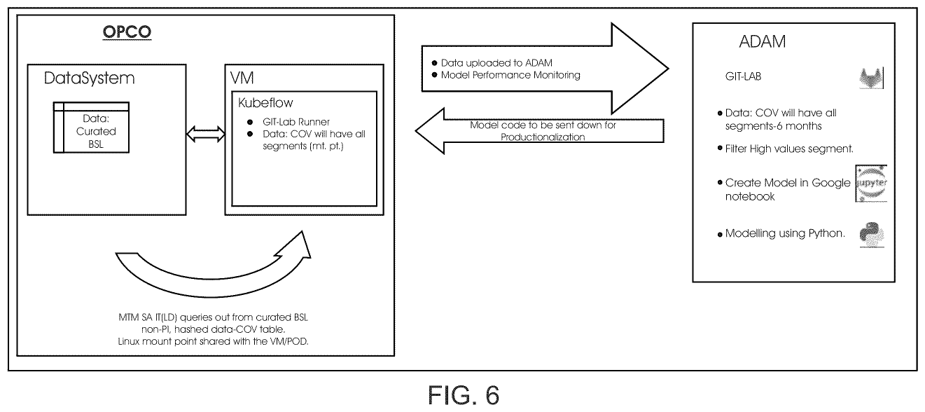

FIG. 6 provides an overview of an exemplary ADAM platform in operation. The Business Semantic Layer (“BSL”) includes curated and governed data location where business users will consume already generated metrics and KPI's.

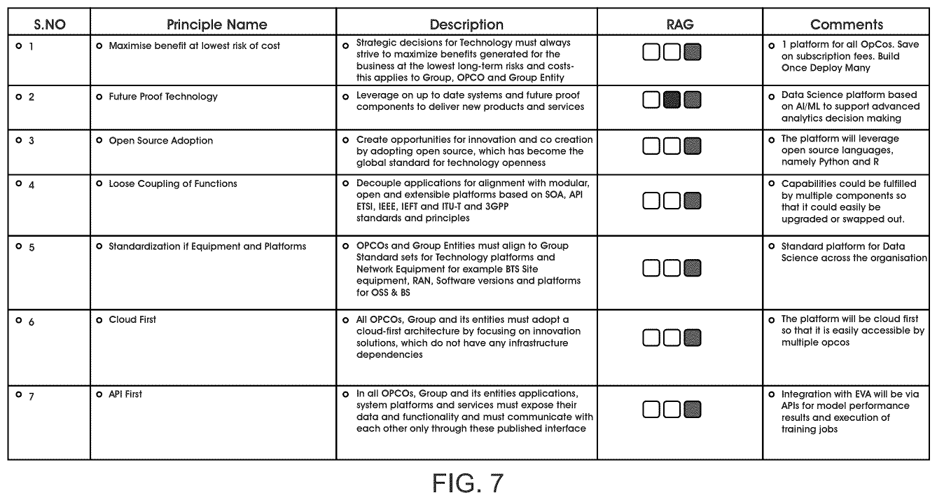

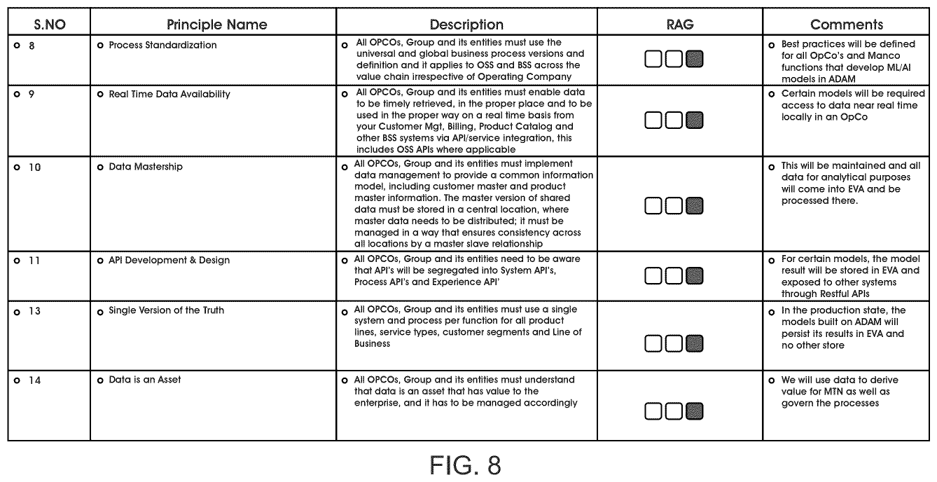

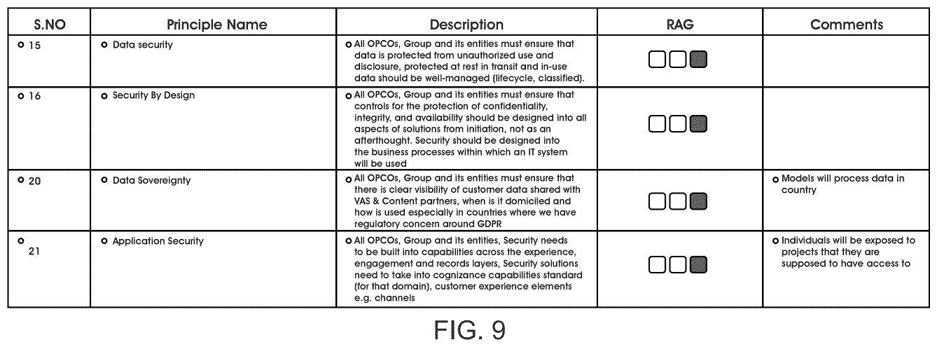

FIGS. 7-9 detail an exemplary ADAM platform's compliance with a set of architectural principles.

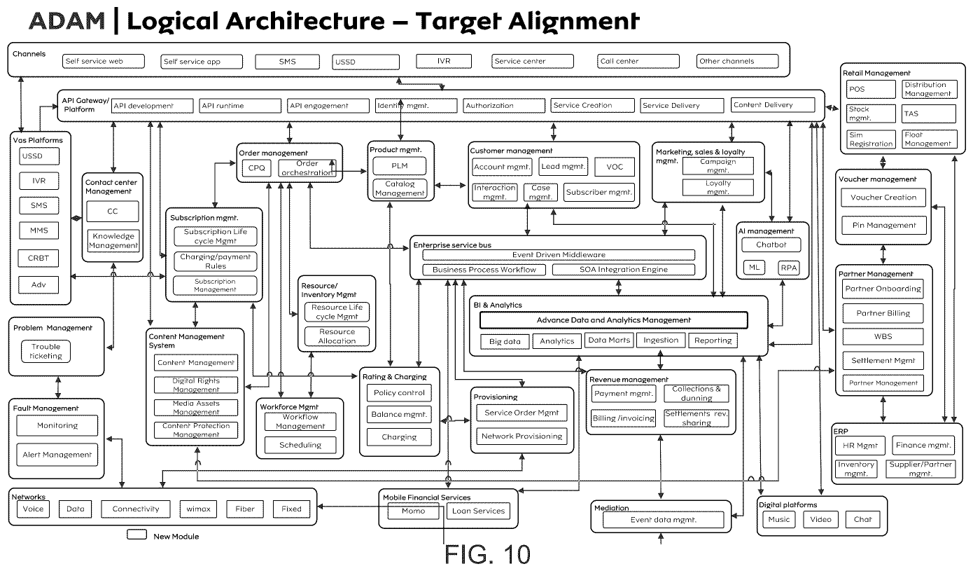

FIG. 10 is a schematic diagram of an exemplary logical architecture that may be employed in embodiments of the invention.

Table 1 below summarises various layers of an exemplary architectural blueprint to indicate the overall responsibilities each component layer of the architecture may provide to realise the ADAM platform.

TABLE 1

| Component/Layer | Description |
|---|---|
| Training Datamarts | Dummy anonymized required/specific EVA data schema for |
| | model training/creation. |
| AA Datamart | AA Datamart - feature Datamart pre-created standard for |
| | creating all models and updated as new features are needed. |
| Asset Catalogue & | List of all models created, with input set and output (predicted) |
| Model Libraries | variables, frequency etc. For make once use many type re-use |
| | into other OpCo and localization. |
| Workbench/IDE - | Standardisation of Development processes and Languages |
| Modelling | like - R, Python |
| language | |
| Single truth data | Model Master will be the ADAM, and single source of |
| repositories | information will be EVA. ADAM control/management plane will |
| | not store any real data, but only model library and anonymised |
| | data for model training. Results of models will be stored in |
| | EVA. |
| Data & Analytics | User plane will be in each OpCo to deploy model into EVA and |
| | run it in EVA. OpCo dynamics and anonymized data will be |
| | pulled from EVA into centralised control/management plane |
| | for model creation. |
| Technology | ADAM user plane layer will be on-premise. |
| infrastructure | Single Source of Data for Analytics: all model management, |
| | creation, library, retrain, localization for re-use in OpCo will be |
| | in a centralized location. This is make sure that no local |
| | regulatory requirement is breached like GDRP or POPI. |

The ADAM platform may be split into two logical components: a control/management plane and a user plane. The control/management plane may be centralized, e.g. at a group level in the organisation, where most ADAM activities would be running and available to all connected OpCos. In some cases, the control/management plane may have only dummy or anonymized data. Some OpCos may develop outside of ADAM and models could be imported into ADAM. In the user plane, any model or other analytical asset developed on the ADAM platform would be deployed to run locally in an OpCo (or other local/on-premise point) and the control/management plane may be configured to monitor performance and accuracy of models. For entities in embargoed countries, for example, developed models may run locally without the need for the control plane of ADAM to have connectivity.

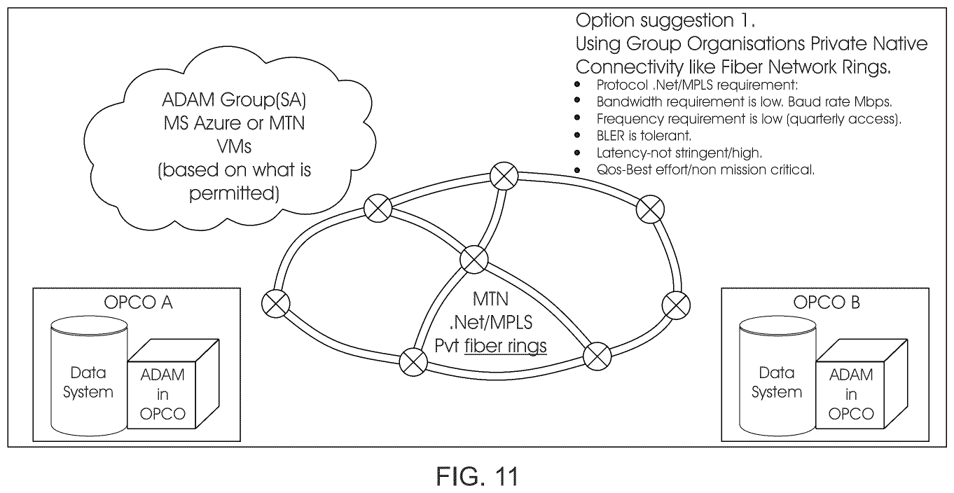

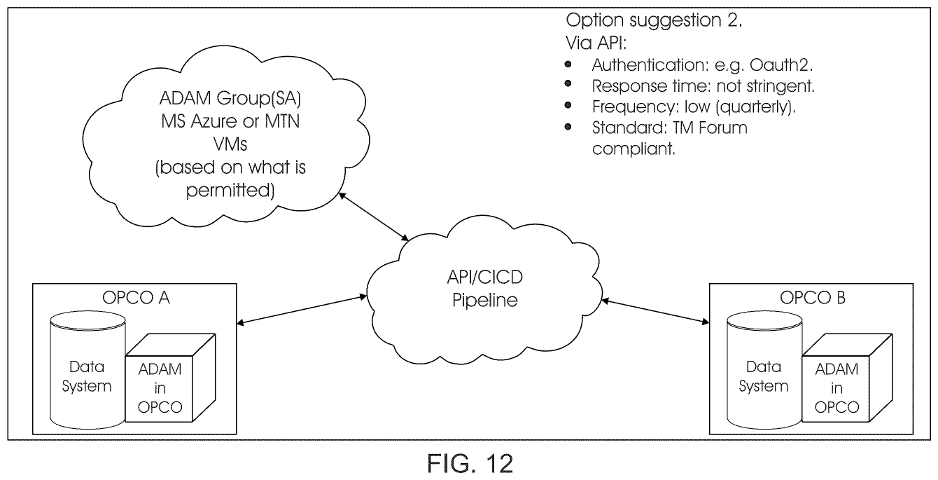

FIGS. 11 and 12 show two exemplary options for integrating the ADAM platform into OpCo entities, again using MTN as an example. In essence, option 1 makes use of fiber network rings and network nodes as a network topology, which then makes use of the NET software framework together with the MPLS (Multiprotocol Label Switching) is a routing technique. Option 2 in FIG. 12 makes use of CI/CD as a software development methodology to help improve the speed and efficiency of the software development process by allowing for the building, testing, and deployment of software by building and testing code changes as they are committed to a code repository. In essence, the options

Table 2 below summarises some exemplary capabilities/modules of the ADAM platform.

TABLE 2

| # | Capability | Description |
|---|---|---|
| 1 | Multi-users | Allows multiple users to use the system/platform same |
| | | time |
| 2 | Client-Server | Computation and processing happens in the cluster |
| | Interface | sent via web/mobile app |
| 3 | Drag and Drop | Makes it easy for citizen data scientist to develop |
| | Model Development | models via drag and drop |
| 4 | Model Packaging | Allows deployment of model as a REST service/micro- |
| | and Deployment | service |
| | using Continuous | |
| | Integration | |
| 5 | Model Deployment | Allows model jobs to run on the cluster, i.e. take |
| | Hadoop Cluster | advantage of distributed resources |
| | Support | |
| 6 | Model Hyper tuning | Supports model parameter optimization |
| | and Grid Search | |
| 7 | Ensemble/Stacking | Supports model stacking |
| | Model Development | |
| 8 | Model Monitoring | Supports live model's status checks e.g. running, |
| | | stopped, error, etc. |
| 9 | Model Collaboration | Allows teams to work on the same model via SVN of |
| | Development | GitHub |
| 10 | Model Development | Allows models owner to have access-controlled |
| | Access Right Control | environment |
| 11 | Auto Data Clean- | Ensures unused data is archived |
| | up/Archive | |
| | Movement | |
| 12 | Parallel Progressing | Allows writing and running parallel code |
| 13 | Artificial Intelligence | Beyond ML, allows drag and drop of setting actions on |
| | Support | insights |
| | (Optimization) | |
| 14 | GPU/TPU | Supports running Deep Learning on GPU/TPU |
| 15 | Existing Use Cases | Easily deploy them in the new data science platform |
| 16 | IDE | Jupyterlab/Zepplin |
| 17 | Data | Structured & unstructured |
| 18 | Programming | Open source and automation tools |
| | language | |
| 19 | Hardware | CPU; GPU; TPU |
| 20 | Model Deployment | Multiple deployment options (E.g. MLFlowor |
| | | equivalent) |
| 21 | System Integration | Standards-based integration with line of business |
| | | applications. |
| | | Leverages existing investments, e.g. in Hadoop |
| 22 | Organisation (e.g. | Compliance with standards set by organisation. |
| | group level) | Operating system and environment support (cloud, on |
| | Standards | premise, or hybrid cloud). |
| | | Security standards: authentication, authorization, and |
| | | data access. |
| | | Flexibility in platform deployment. |

The platform may cater for collaboration, internal crowdsourcing, and leveraging of assets, and may be configured to permit cloud, edge and on-premises local deployment and execution of analytical resources, for instance in a group headquarters office, in any of the operating companies, in satellite units, at client premises, and/or public places across the globe.

The ADAM platform may further:
integrate a company's internal and external customers and partners like operating companies, and group functions (CVM, Fintech, Sales, Enterprise, Network, Technology, Public (Government) and Private partnerships).
enable and enrich all lines of business inside and outside the organisation by enhancing or improving existing ways of working, use cases, and providing a whole new breed of intelligent AI/ML analytical solutions like real-time insights and alert-based actions and data-driven decision making.
enhance productivity and effectiveness of data scientists, business analysts, non-technical employees, and senior management.
empower a strategy of modernising an organisation by changing the approach toward data and analytics, nurturing an environment conducive to the proliferation of the benefits of data and analytics.

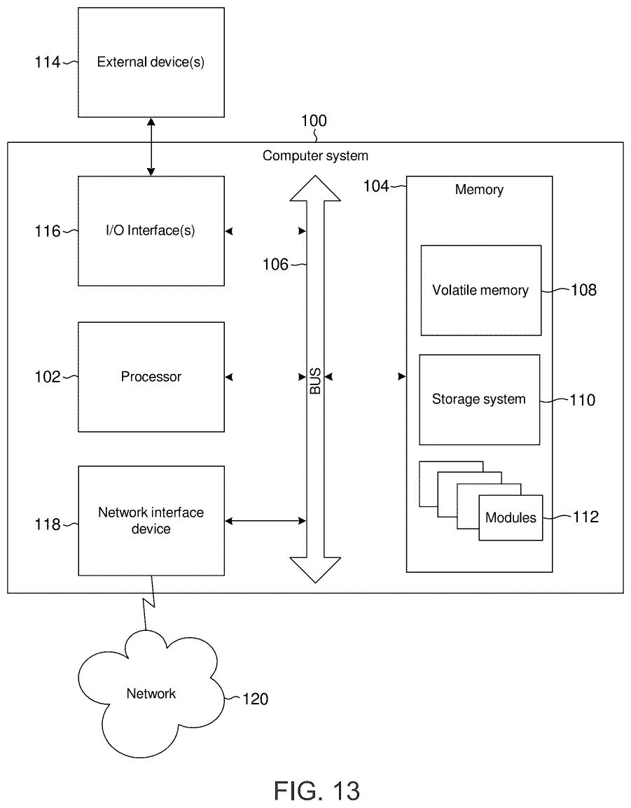

One or more techniques described above may be implemented in or using one or more computer systems, such as the computer system 100 shown in FIG. 13. The computer system 100 may be or include any suitable computer or server. The computer system 100 may be implemented in distributed cloud computing environments where tasks are performed by remote processing devices that are linked through a communications network. In a distributed cloud computing environment, program modules executed by the computer system 100 may be located both locally and remotely.

In the example shown in FIG. 13, the computer system 100 has features of a general-purpose computer. These components may include, but are not limited to, at least one processor 102, a memory 104 and a bus 106 that couples various components of the system 100 including the memory 104 to the processor 102. The bus 106 may have any suitable type of bus structure. The computer system 100 may include one or more different types of readable media, such as removable and non-removable media and volatile and non-volatile media.

The memory 104 may thus include volatile memory 108 (e.g. random access memory (RAM) and/or cache memory) and may further include other storage media such as a storage system 110 configured for reading from and writing to a non-removable, non-volatile media such as a hard drive. It will be understood that the computer system 100 may also include or be coupled to a magnetic disk drive and/or an optical disk drive (not shown) for reading from or writing to suitable non-volatile media. These may be connected to the bus 106 by one or more data media interfaces.

The memory 104 may be configured to store program modules 112. The modules 112 may include, for instance, an operating system, one or more application programs, other program modules, and program data, each of which may include an implementation of a networking environment. The components of the computer system 100 may be implemented as modules 112 which generally carry out functions and/or methodologies of embodiments of the invention as described herein. It will be appreciated that embodiments of the invention may include or be implemented by a plurality of the computer systems 100, which may be communicatively coupled to each other.

The computer system 100 may operatively be communicatively coupled to at least one external device 114. For instance, the computer system 100 may communicate with external devices 114 in the form of a modem, keyboard and display. These communications may be effected via suitable Input/Output (I/O) interfaces 116.

The computer system 100 may also be configured to communicate with at least one network 120 (e.g. the Internet or a local area network) via a network interface device 118/network adapter. The network interface device 118 may communicate with the other elements of the computer system 110, as described above, via the bus 106.

The components shown in and described with reference to FIG. 13 are examples only and it will be understood that other components may be used as alternatives to or in conjunction with those shown.

### Working Example

With reference to the teachings of FIGS. 1 to 13 above, the invention can be illustrated through use of an example application of the invention within the various OpCos of MTN.

The EVA systems in several countries generates and/or obtains large data sets pertaining to customer behaviour, spending habits, and the like. This data is then anonymized by each of these EVA systems and uploaded to the ADAM platform. The various models, algorithms, operations and further functionalities are performed by the ADAM model on the anonymized data sets. Importantly, each instance where the ADAM model is trained by a anonymized data set, regardless of the similarity of that data set with any other data set, the ADAM model will be capable of analyzing and making predictions for each anonymized data set as the ADAM model is continuously trained. Herein lies one of the unique features of the ADAM model being centralized; it is not simply trained by homogenous data sets, but continuously improved by the unique anonymized data sets provided by OpCos.

Once the ADAM model has been trained, the model code can be downloaded and deployed on each EVA system for use on the real data.

With particular reference to the MTN OpCos, the ADAM model has been trained and subsequently deployed as follows:
Predicting X amount of days when customers will likely go inactive, such that these customers can be targeted with personalized campaigns;
Segment customers into different segments in order to target customers with tailored campaigns;
Identify data usage trends of customers in order to target customers with tailored campaigns at opportune times; and
Identify whether customers are located in a home, business, hospital, or other organization, and whether they are members of the same organization in order to target customers with tailored campaigns.

These are but a few examples, but is should importantly be noted that the data sets from different OpCos in different sectors and/or having different functions allows for the identification of important trends that would otherwise not be possible where a model simply uses homogenized data sets.

### FURTHER CONSIDERATIONS

Aspects of the present invention may be embodied as a system, method and/or computer program product. Accordingly, aspects of the present invention may take the form of hardware, software and/or a combination of hardware and software that may generally be referred to herein as “components”, “units”, “modules”, “systems”, “elements”, or the like.

It will be understood that a module as used in the claims hereunder is a set of code or a software program capable of performing one or more specific tasks. It will be further understood that each module includes a plurality of software programs or code capable of performing a same or similar function.

The communicatively coupled shall refer to, but not be limited to, the exchange of information, commands, or data between devices or platforms.

Furthermore, aspects of the present invention may take the form of a computer program product embodied in one or more computer-readable storage medium having computer-readable program code embodied thereon. A computer-readable storage medium may, for instance, be an electronic, magnetic, optical, electromagnetic, infrared, or semiconductor system, apparatus, or device, or any suitable combination of the above. In the context of this specification, a computer-readable storage medium may be any suitable medium capable of storing a program for execution or in connection with a system, apparatus, or device. Program code/instructions may execute on a single device, on a plurality of devices (e.g., on local and remote devices), as a single program or as part of a larger system/package.

The present invention may be carried out on any suitable form of computer system, including an independent computer or processors participating on a network of computers. Therefore, computer systems programmed with instructions embodying methods and/or systems disclosed herein, computer systems programmed to perform aspects of the present invention and/or media that store computer-readable instructions for converting a general purpose computer into a system based upon aspects of the present invention, may fall within the scope of the present invention.

Chart(s) and/or diagram(s) included in the figures illustrate examples of implementations of one or more system, method and/or computer program product according to one or more embodiment(s) of the present invention. It should be understood that one or more blocks in the figures may represent a component, segment, or portion of code, which comprises one or more executable instructions for implementing specified logical function(s). In some alternative implementations, the actions or functions identified in the blocks may occur in a different order than that shown in the figures or may occur concurrently.

It will be understood that blocks or steps shown in the figures may be implemented by system components or computer program instructions. Instructions may be provided to a processor of any suitable computer or other apparatus such that the instructions, which may execute via the processor of the computer or other apparatus, establish or generate means for implementing the functions or actions identified in the figures.

1. A data management platform comprising:
a centralized database having benchmark data stored thereon, the centralized database configured to receive one or more data sets from one or more data sources, and wherein the centralized database allows for one or more users to remotely access the centralized database;
an analytics module communicatively coupled to the centralized database, the analytics module comprising one or more analytics tools which allows for data analysis of the one or more data sets; and
a model module communicatively coupled to the centralized database, the model module comprising one or more algorithms for performing a set of instructions on the one or more data sets, wherein the model module is capable of being trained by the one or more algorithms by comparing the one or more data sets to the benchmark data to derive one or more output data sets having predictive information about the one or more data sets.

2. The data management platform according to claim 1, wherein the one or more data sources are one or more data warehouses locatable in one or more countries.

3. The data management platform according to claim 1 configured to allow for the one or more users to remotely access the centralized database through a network connection to transfer one or more data sets from one or more data sources to the centralized database, wherein the network connection allows for the one or more users to use the analytics module comprising analytics tools to analyse the one or more data sets, and wherein the network connection allows for the one or more users to train the model module comprising one or more algorithms by comparing the one or more data sets to the benchmark data to derive an output dataset having predictive information about the one or more data sets.

4. The data management platform according to claim 1, wherein the analytics module comprising one or more analytics tools and the model module comprising one or more algorithms are dynamically updated and evolve with each instance of the one or more analytics tools analysing the one or more data sets and each instance of the model module being trained by the one or more algorithms by comparing the one or more data sets to the benchmark data to derive one or more output data sets having predictive information about the one or more data sets.

5. The data management platform according to claim 1, wherein the one or more analytics tools are selected from the group consisting of Tableau, Oracle Business Intelligence, IBM Cognos Analytics, SAS, Microsoft Power BI, Amazon Redshift, Google BigQuery, Snowflake, Alteryx, Cloudera, Apache Hadoop, Google Vertex AI, Microsoft Azure Synapse, Microsoft Data Explorer, CosmosDB, Redis, Azure Cognitive Services, Azure Machine Learning, Spark, Databricks, Sqream, Confluent Kafka, Presto, Trino, Flare, HIDS, and combinations thereof.

6. The data management platform according to claim 1, wherein the one or more algorithms are selected from the group consisting of a machine learning algorithm, an artificial intelligence algorithm, a deep learning algorithm, a heuristic algorithm, and combinations thereof.

7. The data management platform according to claim 1, wherein the one or more data sets comprises customer usage information selected from the group consisting of customer voicecall usage, customer screentime usage, customer data usage, customer messaging usage, customer device hardware specifications, customer transactions, customer interactions, customer behaviour, customer revenue, network operations, network usage, network investment, internal operations, sale information, distribution information, agent operations, merchant operation, agent services, merchant operation, business to business products, business to business products services, digital products, over-the-top applications, customer value management, pricing, operations management, portfolio management, customer location, network location, network transport, network configuration, cybersecurity, and combinations thereof.

8. The data management platform according to claim 1, wherein the predictive information comprises information about customer's behaviour to derive a user-specific product offering.

9. The data management platform according to claim 1, wherein the centralized database is configured to only receive one or more data sets that have been anonymized to derive anonymized data.

10. The data management platform according to claim 1 further comprising a data transmission module for transmission of the model module to a database that is locatable outside of the centralized database, wherein the model module comprising one or more algorithms is capable of being applied on one or more data sets available on the database to derive an output dataset having predictive information about the one or more data sets.

11. The data management platform according to claim 10, wherein the model module is capable of being stored on a storage medium.

12. The data management platform according to claim 11, wherein the storage medium is selected from the group consisting of a non-transitory storage medium, transitory storage medium, and combinations thereof.

13. The data management platform according to claim 1 further comprising an anonymizing module locatable outside of the centralized database, the anonymizing module comprising:
a data module for receiving the one or more data sets from one or more data sources;
an anonymizing algorithm for anonymizing the one or more data sets to derive anonymized data; and
a transmission module for transmission of the anonymized data to the centralized database.

14. The data management platform according to claim 13, wherein the anonymized data is used to train the model module by the one or more algorithms comparing the anonymized data to benchmark data stored on the centralized database to derive an output dataset having predictive information about the anonymized data.

15. The data management platform according to claim 14, wherein the model module is configured to be trained by anonymized data, and wherein the model module is applied on one or more data sets locatable at a selected location to comply with country-specific data protection and privacy regulation regulations.

16. The data management platform according to claim 1 further comprising an interface module which is communicatively coupled to the model module to receive the predictive information about the one or more data sets, and which is further and which is further communicatively coupled to one or more user devices, thereby allowing the user devices to access the predictive information about the one or more data sets.

17. A method for training a model with anonymized data and applying the model on one or more data sets located at a selected location, the method comprising the steps of:
providing a database having benchmark data stored thereon, wherein the database is capable of receiving data from one or more data sources;
providing an external data source that is communicatively coupled to the database, wherein one or more data sets stored on the external data source is anonymized by performing a set of instructions thereon to derive anonymized data;
using one or more analytics tools to allow for data analysis of data stored on the database;
training a model comprising one or more algorithms by comparing the anonymized data to the benchmark data;
applying the trained model on one or more data sets that are locatable outside of the database to derive predictive information about the one or more data sets.

18. The method according to claim 17 further comprising the step of storing the model on a storage medium, which allows for the model to be applied on one or more data sets that are communicatively coupled to the storage medium.

19. A digital management system comprising:
a computing device comprising a processor communicatively coupled to a memory which is capable of storing one or more data sets obtainable from one or more data sources thereon, the memory having benchmark data stored thereon;
an analytics module comprising analytical tools, the analytics module communicatively coupled to the memory, wherein the processor is capable of carrying out a set of instructions for the analytical tools to perform analytical operations on the one or more data sets; and
a model module comprising one or more algorithms, the model module communicatively coupled to the memory, wherein the model module is capable of being trained by the processor applying the one or more algorithms by comparing the one or more data sets to benchmark data to derive an output dataset having predictive information about the one or more data sets.

20. The digital management system according to claim 19, wherein the memory is selected from the group consisting of non-transitory storage medium, transitory storage medium, and combinations thereof.
